(19) United States
(12) Patent Application Publication
(10) Pub. No.: US 2023/0091485 A1
(43) Pub. Date: Mar. 23, 2023

(54) RISK PREDICTION IN AGILE PROJECTS

(71) Applicant: International Business Machines Corporation, Armonk, NY (US)

(72) Inventors: Katsuroh Hayashi, Fujisawa-shi (JP); Hideaki Fujii, Fujisawa-shi (JP); ATSUSHI SANO, TOKYO (JP); TOMOKO MIYOSHI, Tokyo (JP)

(21) Appl. No.: 17/481,358

(22) Filed: Sep. 22, 2021

(51) Int. Cl. G06Q 10/06; G06N 5/04

(52) U.S. Cl. CPC G06Q 10/0635; G06N 5/04

(57) ABSTRACT

An approach is disclosed that receives estimates pertaining to tasks in a project from project members working on an agile project. The estimates are adjusted using corrections received from an artificial intelligence (AI) system using a previously trained model with each of the corrections pertaining to one of the estimates. A risk level of the project is determined based on the corrected estimates. Completion data sets are then received from the project members upon completion of the project members' respective tasks. The completion data sets are then used to further training the AI system's model.

### BACKGROUND

Agile is a way of producing software in short iterations on a continuous delivery schedule. Other areas of focus include self-organizing teams, simplicity, sustainable pace of development, and change based on customer feedback. The “Agile Manifesto” dates to 2001, when software development practices were nothing like they are today. Back then, it was typical to spend a year planning and writing specifications and another year writing and testing code. By the time any software shipped, it was already 2 years behind what customers were looking for. According to the manifesto, an agile culture values individuals, interactions, working software, collaboration with customers, and response to change. The principles of the Agile Manifesto can guide teams to define, design, develop, and deliver innovative solutions across the entire lifecycle, roles, and disciplines.

### SUMMARY

An approach is disclosed that receives estimates pertaining to tasks in a project from project members working on an agile project. The estimates are adjusted using corrections received from an artificial intelligence (AI) system using a previously trained model with each of the corrections pertaining to one of the estimates. A risk level of the project is determined based on the corrected estimates. Completion data sets are then received from the project members upon completion of the project members' respective tasks. The completion data sets are then used to further training the AI system's model.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a block diagram of a processor and components of an information handling system such as those shown in FIG. 1;

FIG. 3 is a diagram depicting interactions between project members, the project management system, and the cognitive computing system in agile project development;

FIG. 4 is a depiction of a high-level flowchart showing the logic used in an embodiment of agile project development with risk determination;

FIG. 5 is a depiction of a flowchart showing the logic used in correcting estimations;

FIG. 6 is a depiction of a flowchart showing the logic used for risk determination; and

FIG. 7 is a depiction of a flowchart showing the logic used to improve determination logic used in the process.

### DETAILED DESCRIPTION

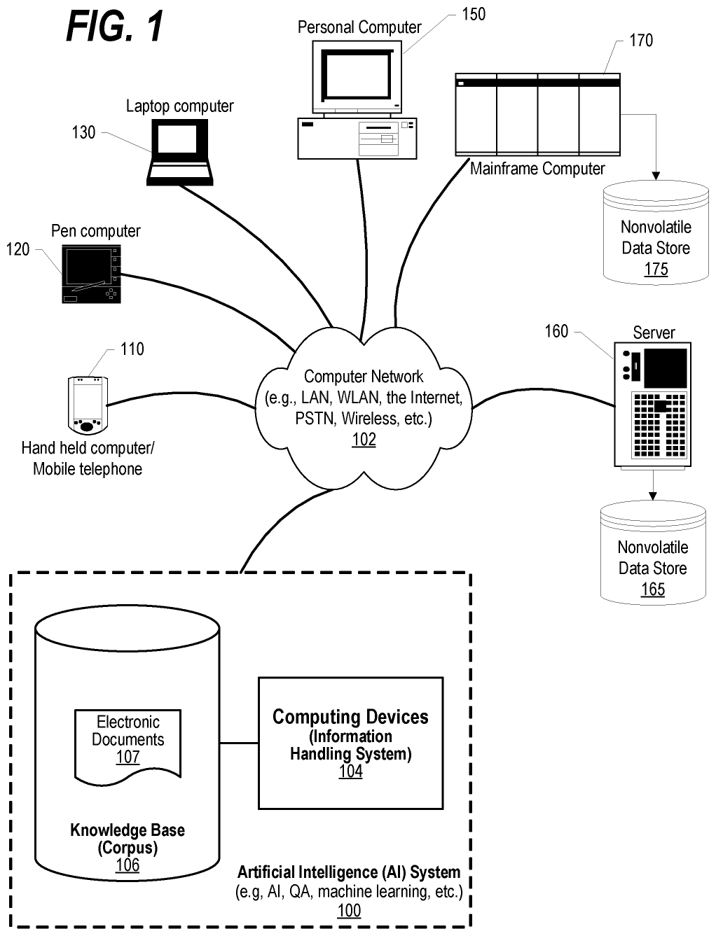

FIGS. 1-7 describe an approach of agile project development with risk determination. Agile project management is an approach to process tasks created in units of stories, in which a virtual unit called a story point is used to estimate a workload in planning and members estimate a workload of each story. For example, a method called planning poker is adopted to estimate a value of story point based on a consensus achieved among all estimators. The process to determine the story point includes steps as follows: (1) Each estimator reveals his/her story point; (2) If there is a variation in estimated values, estimators share their opinions, based on which the estimators revise their estimated values and reveal their values again; and (3) Step 2 is repeated until estimated values are made to converge.

A degree of reliability (or degree of risk) of estimated value varies depending on the story. In the agile project management, a work subject of the next cycle is estimated when uncertainty of a story becomes clear to some extent. However, some stories are accompanied by a high risk such as requiring a heavier workload than an estimated original value due to occurrence of unexpected circumstance, etc. Without certain criteria for a degree of risk involved in an estimated value of a story at the start of task, a person to whom the story was assigned will carry out a task while feeling anxious about all stories. The person may also be tossed about by the sudden occurrence of problem if he/she is careless. Even though a story point is provided based on a final consensus achieved among estimators, the estimators may be left with a concern about overlooking of their first impressions.

Assuming that, for example, a degree of risk involved in an estimated value is predictable, there is an advantage of enabling advanced careful task implementation and preparation for a countermeasure which is as effective as possible with caution. Above all, a state of being mentally prepared leads to mental relief. Principle of the approach described herein: Attention is paid to estimators' first impressions revealed by their estimated values in the first step in the process of determining a story point by them. Each members' intuition appears to act on the first impression. If these values vary significantly, it is imaginable that a certain discouraging factor may be hidden. Therefore, a method is explored to determine a risk hidden in estimated values from the tendency of variations in estimated values at the first step on which the estimators' first impressions act.

This approach provides for acknowledging a potential deviation of workload (risk level) and the magnitude of the deviation (difference between a value initially estimated by each estimator and a final estimated value based on consensus) in planning of stories implemented by agile development. The approach takes risk reduction/avoidance into consideration in planning by acknowledging the risk level. The approach allows project members to process stories more safely and certainly such that, for example, a countermeasure at the occurrence of risk can be preplanned by predicting potential necessity of workload beyond the estimated workload and the amount of the workload, and more effective planning can be realized by planning in view of only story priority but also a risk level.

FIG. 1 depicts a schematic diagram of one illustrative embodiment of artificial intelligence (AI) system 100 in a computer network 102. AI system 100 includes artificial intelligence computing device 104 (comprising one or more processors and one or more memories, and potentially any other computing device elements generally known in the art including buses, storage devices, communication interfaces, and the like) that connects AI system 100 to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. AI system 100 and network 102 may enable functionality, such as question/answer (QA) generation functionality, for one or more content users. Other embodiments of AI system 100 may be used with components, systems, sub-systems, and/or devices other than those that are depicted herein.

AI system 100 maintains knowledge base 106, also known as a “corpus,” which is a store of information or data that the AI system draws on to solve problems. This knowledge base includes underlying sets of facts, assumptions, models, and rules which the AI system has available in order to solve problems.

AI system 100 may be configured to receive inputs from various sources. For example, AI system 100 may receive input from the network 102, a corpus of electronic documents 107 or other data, a content creator, content users, and other possible sources of input. In one embodiment, some or all of the inputs to AI system 100 may be routed through the network 102. The various computing devices on the network 102 may include access points for content creators and content users. Some of the computing devices may include devices for a database storing the corpus of data. The network 102 may include local network connections and remote connections in various embodiments, such that artificial intelligence 100 may operate in environments of any size, including local and global, e.g., the Internet. Additionally, artificial intelligence 100 serves as a front-end system that can make available a variety of knowledge extracted from or represented in documents, network-accessible sources and/or structured data sources. In this manner, some processes populate the artificial intelligence with the artificial intelligence also including input interfaces to receive knowledge requests and respond accordingly.

In one embodiment, the content creator creates content in electronic documents 107 for use as part of a corpus of data with AI system 100. Electronic documents 107 may include any file, text, article, or source of data for use in AI system 100. Content users may access AI system 100 via a network connection or an Internet connection to the network 102, and, in one embodiment, may input questions to AI system 100 that may be answered by the content in the corpus of data. As further described below, when a process evaluates a given section of a document for semantic content, the process can use a variety of conventions to query it from the artificial intelligence.

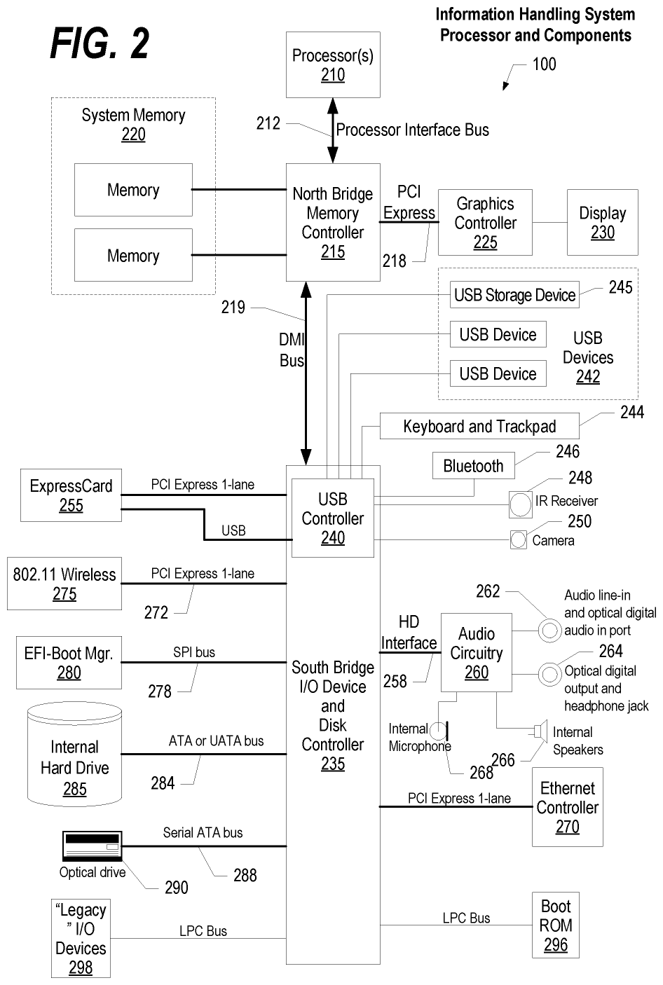

Types of information handling systems that can utilize AI system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE 0.802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

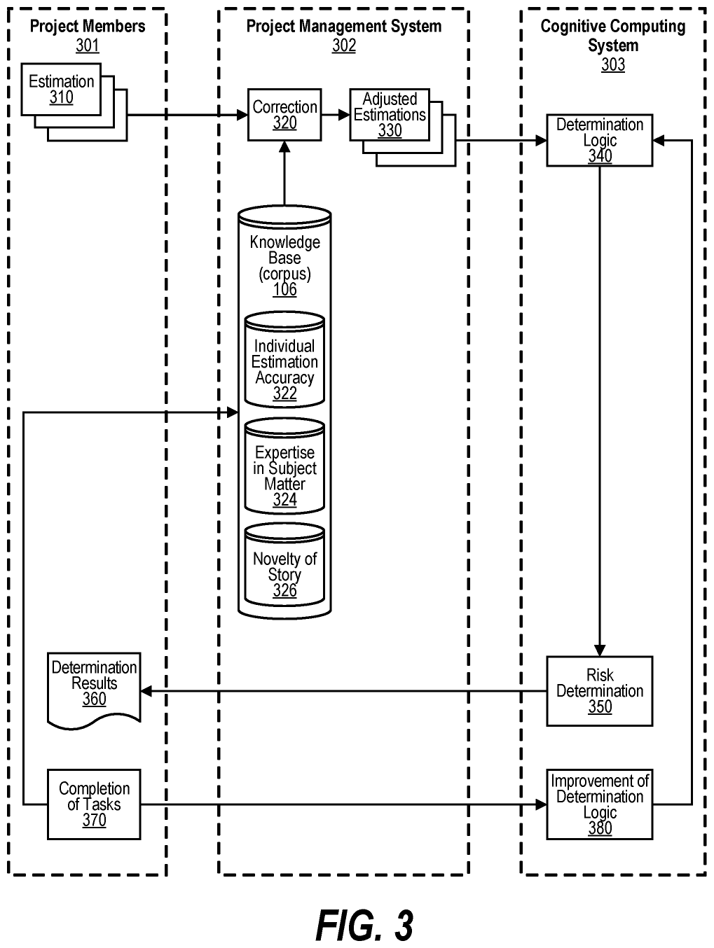

FIG. 3 is a diagram depicting interactions between project members, the project management system, and the cognitive computing system in agile project development. The approach uses the following processing steps outlined in FIG. 3. Project members 301 estimate their own story workloads (estimation 310) by using virtual units called story points. Project management system 302 performs correction process 320 to correct values estimated by the project members based on data such as ‘individual estimation accuracy,’‘expertise in estimated subject,’ and ‘novelty of story.’ Correction process 320 results in corrected estimations 330.

Data used to perform corrections includes the following: “Individual estimation accuracy,” to correct each individual based on his/her past estimation and result. For example, Mr. A tends to overestimate a workload so that his estimated value is multiped by a value such as 0.9. For example, Ms. B tends to underestimate a workload so that her estimated value is multiplied by a value such as 1.1. “Expertise in estimated subject,” to correction each individual depending on whether he/she has expertise in an estimated subject. For example, Mr. A has expertise in an estimated subject so that no correction is applied to his estimated value. For example, Ms. B has no expertise in an estimated subject so that her estimated value is multiplied by a value such as 1.1 in the same manner as “individual estimation accuracy.” “Novelty of story,” if a story involves novelty, all members' estimated values are multiplied by a value such as 1.1.

The project management system transmits corrected estimated values to cognitive computing system 303. The cognitive computing system performs determination logic process 340 for risk determination as follows. For example, Determination based on the standard deviation, or Determination of the difference between the maximum value and the minimum value, or Determination based on a value obtained by dividing the difference between the maximum value and the minimum value by the final estimated value. Other determination logics may be used based on the environment and other factors.

The cognitive computing system determines risk by performing risk determination process 350 as follows. For example, the logic may determine the risk to be high when the standard deviation is a value such as 3 or above, middle when it is a value such as 1 or above and less than a value such as 3, and low when it is less than a value such as 1. In one embodiment, for example, the logic determines the risk to be high when the difference between the maximum value and the minimum value is a value such as 7 or above, middle when it is a value such as 3 or above and less than a value such as 7, and low when it is less than a value such as 3. In one embodiment, for example, the logic determines the risk to be high when a value obtained by dividing the difference between the maximum value and the minimum value by the final estimated value is a value such as 1 or above, middle when it is a value such as 0.5 or above and less than a value such as 1, and low when it is less than a value such as 0.5.

The cognitive computing system notifies the project members of the risk determination results 360. Project members 301 complete tasks (process 370) while referring to the risk determination result. The project members notify the project management system 302 of results of completed tasks to improve data such as ‘individual estimation accuracy,’‘expertise in estimated subject,’ and ‘novelty of story’ and improve criteria for determination logic. Cognitive system 303 uses the results to perform improvement of determination logic process 380 which is used to improve the logic that is used in the cognitive systems determination step 340, described above.

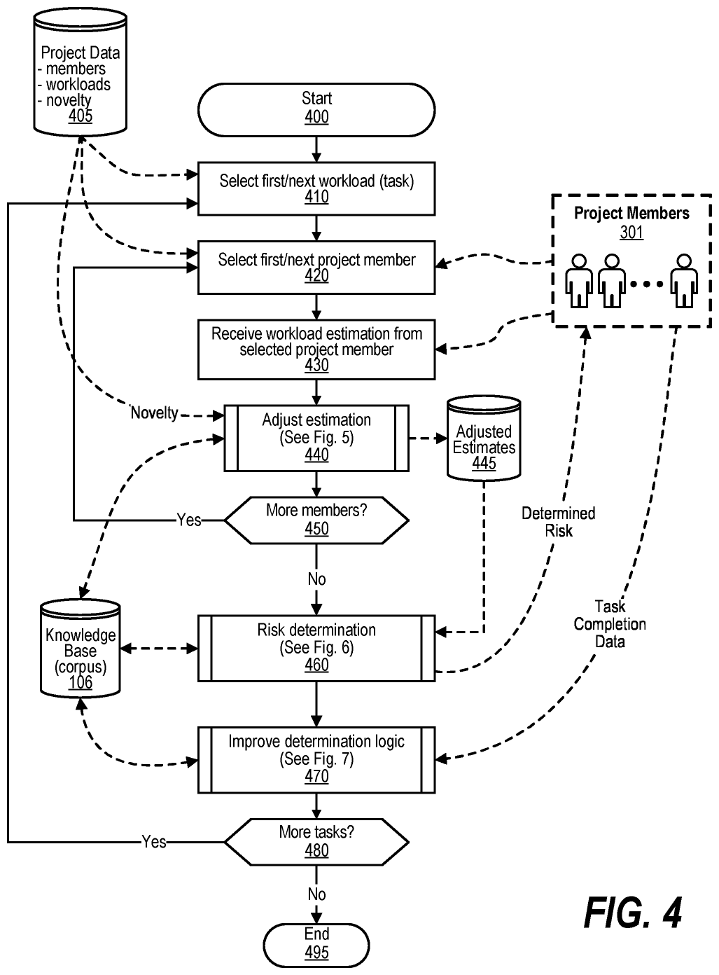

FIG. 4 is a depiction of a high-level flowchart showing the logic used in an embodiment of agile project development with risk determination. FIG. 4 processing commences at 400 and shows the steps taken by a process that determines a risk prediction for agile projects. At step 410, the process selects the first workload (story) from data store 405. In one embodiment, a workload, or story, is a task of the project that is being performed by one or more project members 301. Project data store 405 includes the various tasks in the project (workloads) as well as the project members involved in the agile project and, in one embodiment, also includes a novelty level associated with the task and/or project with the novelty level indicating how new such a task or project is with regard to project members 301.

At step 420, the process selects the first project member from which to receive estimation data. At step 430, the process receives workload (task) estimation from the selected project member, such as the amount of time a particular task will take or how much money a particular task will cost, etc. Multiple task estimations can be received with each such estimations being processed separately.

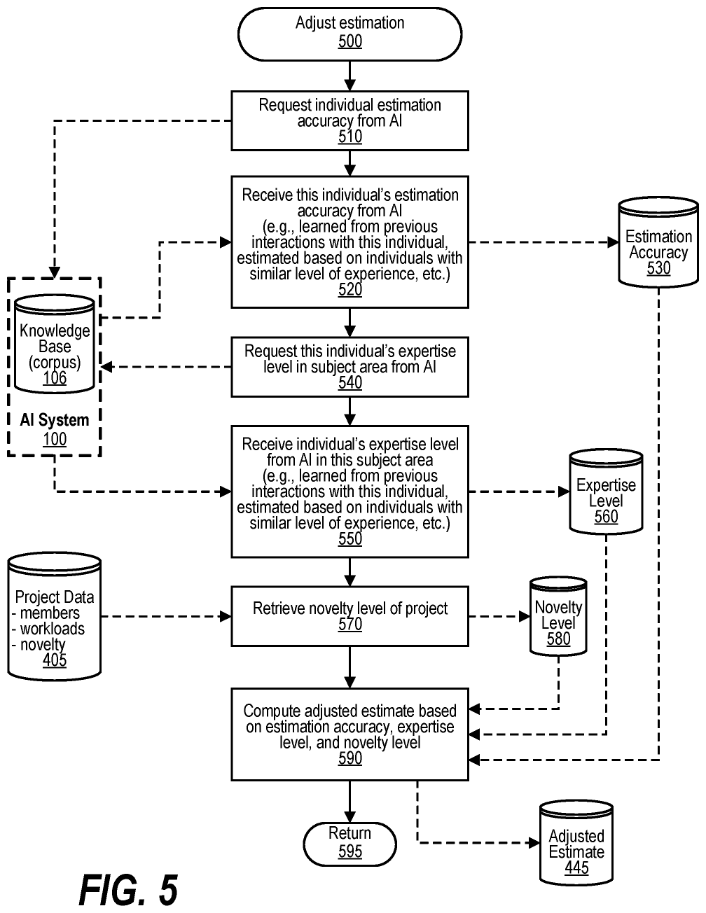

At predefined process 440, the process performs the Adjust Estimation routine (see FIG. 5 and corresponding text for processing details). This routine uses a trained AI system to adjust the estimate received by the project member using a variety of factors such as the member's past estimation accuracy, the member's experience level, and the novelty of the task or project. Predefined process 440 stores the adjusted estimates in data store 445. The process determines as to whether there are more project members from which to receive workload (task) estimation data (decision 450). If there are more project members from which to receive workload (task) estimation data, then decision 450 branches to the ‘yes’ branch which loops back to step 420 to receive and process estimation data from the next project member. This looping continues until all of the project members have been processed, at which point decision 450 branches to the ‘no’ branch exiting the loop.

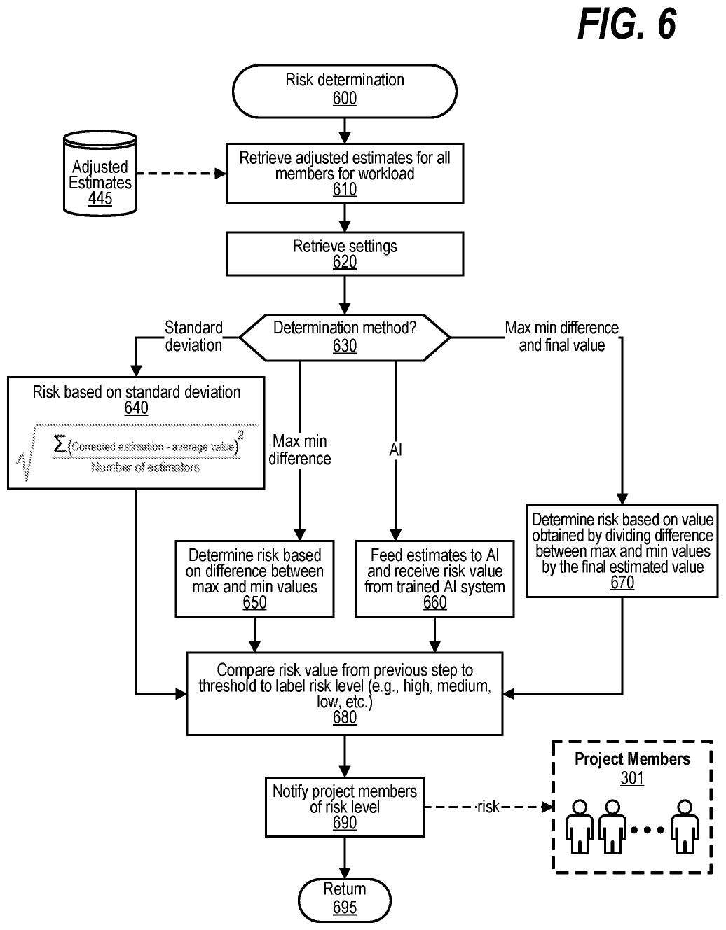

At predefined process 460, the process performs the Risk Determination routine (see FIG. 6 and corresponding text for processing details). This routine takes the adjusted estimates from data store 445 and computes a level of risk that is both retained in the AI's corpus 106 as well as being communicated to the various project members 301.

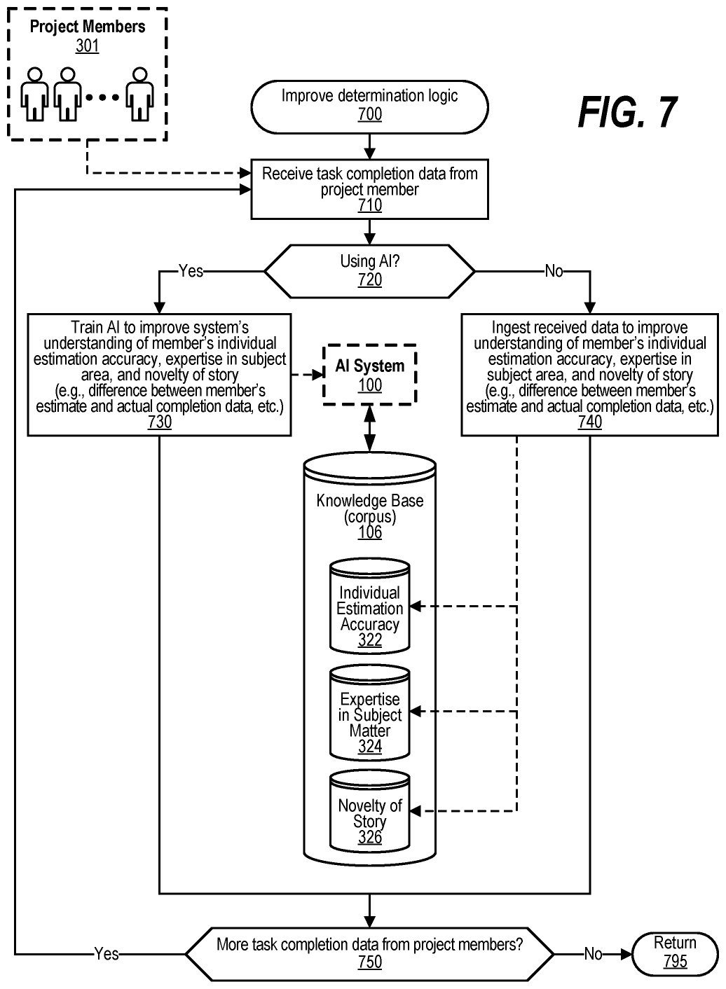

At predefined process 470, the process performs the Improve Determination Logic routine (see FIG. 7 and corresponding text for processing details). This routine receives task completion data from project members 301 and continues to train the AI model that is used to make predictions used to adjust the estimations performed in predefined process 440. The training data is used to update the AI model that is stored in corpus 106 accessible to the AI system.

The process determines as to whether there are more workloads, or tasks, to process (decision 480). If there are more workloads, or tasks, to process, then decision 480 branches to the ‘yes’ branch which loops back to step 410 to select and process the next task for the project that is retrieved from data store 405. This looping continues until there are no more tasks to process, at which point decision 480 branches to the ‘no’ branch exiting the loop. FIG. 4 processing thereafter ends at 495.

FIG. 5 is a depiction of a flowchart showing the logic used in correcting estimations. FIG. 5 processing commences at 500 and shows the steps taken by a process that adjusts estimations received from project members. At step 510, the process requests the individual estimation accuracy corresponding to the project member from AI system 100. AI system utilizes a model that is trained using data regarding project member's previous task estimations as well as the project member's individual levels of experience.

At step 520, the process receives this individual's estimation accuracy from AI system 100. Again, the predicted accuracy from the AI has been learned from previous interactions with this individual, estimated based on individuals with similar level of experience, and the like. In one embodiment, additional “crowd sourced” information is received from the AI system corresponding to individuals found to be similar to the selected project member. This crowd sourced information can be used in combination with the project member's individual estimation accuracy to form an estimation accuracy. Crowd sourced information may be particularly helpful when a project member is relatively new with little to no previous estimations regarding the member ingested to AI system 100 and used to train the AI system's model. The estimation accuracy data is stored in data store 530.

At step 540, the process requests this individual's expertise level in subject area from AI system 100. At step 550, the process receives individual's expertise level from AI in this subject area (e.g., learned from previous interactions with this individual, estimated based on individuals with similar level of experience, etc.). In one embodiment, additional “crowd sourced” information is received from the AI system corresponding to individuals found to be similar to the selected project member. This crowd sourced information can be used in combination with the project member's individual experience level to form an expertise level. Crowd sourced information may be particularly helpful when a project member is relatively new with little to no expertise information regarding the member ingested to AI system 100 and used to train the AI system's model. The expertise level data is stored in data store 560.

At step 570, the process retrieves novelty level of project or task from data store 405. The novelty level that is being used is then stored in data store 580. At step 590, the process computes an adjusted estimate that is based on the project member's estimation accuracy, the project member's expertise level, and the novelty level of the task or project.

As discussed with respect to FIG. 3, in one embodiment the adjusted estimate is calculated based on multiplying the project member's estimate with a multiplier provided by the project member's estimation accuracy, the project member's expertise level, and the novelty level of the task or project. For example, Mr. A tends to overestimate a workload so that his estimated value is multiped by a value such as 0.9. For example, Ms. B tends to underestimate a workload so that her estimated value is multiplied by a value such as 1.1. “Expertise in estimated subject,” to correction each individual depending on whether he/she has expertise in an estimated subject. For example, Mr. A has expertise in an estimated subject so that no correction is applied to his estimated value. For example, Ms. B has no expertise in an estimated subject so that her estimated value is multiplied by a value such as 1.1 in the same manner as “individual estimation accuracy.” “Novelty of story,” if a story involves novelty, all members' estimated values are multiplied by a value such as 1.1. FIG. 5 processing thereafter returns to the calling routine (see FIG. 4) at 595.

FIG. 6 is a depiction of a flowchart showing the logic used for risk determination. FIG. 6 processing commences at 600 and shows the steps taken by a process that performs the risk determination routine. At step 610, the process retrieves adjusted estimates for all members for workload from data store 445. At step 620, the process retrieves settings. These settings include the risk determination method that is used as well as the threshold used to determine the levels of risk (e.g., high risk, medium risk, low risk, etc.). The process determines which determination method is being used (decision 630). Four different determination methods are shown, however additional determination methods can be added and used based on the environment and other factors.

When a standard deviation risk method is used then, at step 640, the process determines the risk level based on a standard deviation algorithm as shown in box 640. When a maximum/minimum risk method is used then, at step 650, the process determines the risk level based on difference between the maximum adjusted estimate values and the minimum adjusted estimate values. When an artificial intelligence (AI) risk processing method is used then, at step 660, the process feeds the adjusted estimates to the AI system and receive a responsive risk value from the trained AI system. When a maximum/minimum and final value risk method is used then, at step 670, the process determines the risk level based on value obtained by dividing difference between max and min values by the final estimated value.

At step 680, the process compares the risk value determined by the previous step to a set of thresholds to label the risk level of the task or project. In one embodiment, risk levels are identified as “high risk,” “medium risk,” and “low risk.” Other additional or intermediate levels can be used as desired. At step 690, the process notifies project members 301 of the risk level that was determined for the task or project. FIG. 6 processing thereafter returns to the calling routine (see FIG. 4) at 695.

FIG. 7 is a depiction of a flowchart showing the logic used to improve determination logic used in the process. FIG. 7 processing commences at 700 and shows the steps taken by a process that performs the Improve Determination Logic routine. At step 710, the process receives task completion data from project members 301. The process determines as to whether the system is using a trained AI model to predict adjustments (decision 720).

If the system is using a trained AI model to predict adjustments, then decision 720 branches to the ‘yes’ branch whereupon, at step 730, the process trains AI system 100 to improve the AI system's understanding (training) of project member's individual estimation accuracy, expertise in subject area, and the novelty of a task or project. For example, the difference between the project member's estimate and the actual completion data for a task is used to train the AI system on the project member's individual estimation accuracy. The completion data is used to train the AI system on the project member's experience in the area of the task. In addition, the novelty is trained to be somewhat less because the project members now have additional exposure and experience with regard to the type of task or project.

On the other hand, if the system is not using a trained AI system, then decision 720 branches to the ‘no’ branch whereupon, at step 740 the process ingests received completion data to improve the system's understanding of project members' individual estimation accuracy, expertise in subject area, and novelty of story so that the data is included in corpus 106 used by the system when predicting the accuracy of project members' estimates in the future. Corpus 106 includes individual estimation accuracy data 322, expertise data of project members in subject matter areas 324, and novelty of task (story) data 326.

The process determines as to whether more task completion data from project members needs to be processed (decision 750). If more task completion data from project members needs to be processed, then decision 750 branches to the ‘yes’ branch which loops back to step 710 to receive and process the next set of completion data from a project member. This looping continues until all of the completion data has been received and processed, at which point decision 750 branches to the ‘no’ branch exiting the loop. FIG. 7 processing thereafter returns to the calling routine (see FIG. 4) at 795.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method, implemented by an information handling system that includes a processor and a memory, the method comprising:
receiving a plurality of estimates pertaining to tasks in a project, wherein each of the estimates is received from one of a plurality of project members working on an agile project;
adjusting one or more of the plurality of estimates with one or more corrections received from an artificial intelligence (AI) system using a previously trained model, wherein each of the corrections pertain to one of the plurality of estimates, and wherein the adjusted estimates are combined with any unadjusted estimates to form a plurality of corrected estimates;
determining a risk level of the project based on the plurality of corrected estimates;
receiving a plurality of completion data sets from the project members upon completion of the project members' respective tasks; and
further training the AI system's model using the received completion data sets.

2. The method of claim 1 wherein the adjusting further comprises:
retrieving an individual estimation accuracy score pertaining to one or more of the project members from the AI system, wherein the adjusting is based on the project members' individual estimation accuracy scores and their respective estimates.

3. The method of claim 1 wherein the adjusting further comprises:
retrieving an individual expertise score pertaining to one or more of the project members from the AI system, wherein the adjusting is based on the project members' individual expertise scores and their respective estimates.

4. The method of claim 1 further comprising:
retrieving an individual estimation accuracy score pertaining to one or more of the project members from the AI system;
retrieving an individual expertise score pertaining to one or more of the project members from the AI system, wherein the adjusting is based on the project members' individual estimation accuracy scores, their individual expertise scores, and their respective estimates.

5. The method of claim 4 further comprising:
receiving a project novelty score pertaining to a novelty of the project,
wherein the adjusting is further based on the project novelty score.

6. The method of claim 1 wherein the training further comprises:
calculating a difference between one or more project members' estimates and an actual completion value included in the respective project members' completion data sets, wherein the training of the AI model is based on the calculated difference.

7. The method of claim 1 further comprising:
communicating the risk level of the project to each of the project members prior to receiving the completion data sets from the project members.

8. An information handling system comprising:
one or more processors;
a memory coupled to at least one of the processors;
a set of computer program instructions stored in the memory and executed by at least one of the processors in order to perform actions comprising:
receiving a plurality of estimates pertaining to tasks in a project, wherein each of the estimates is received from one of a plurality of project members working on an agile project;
adjusting one or more of the plurality of estimates with one or more corrections received from an artificial intelligence (AI) system using a previously trained model, wherein each of the corrections pertain to one of the plurality of estimates, and wherein the adjusted estimates are combined with any unadjusted estimates to form a plurality of corrected estimates;
determining a risk level of the project based on the plurality of corrected estimates;
receiving a plurality of completion data sets from the project members upon completion of the project members' respective tasks; and
further training the AI system's model using the received completion data sets.

9. The information handling system of claim 8 wherein the adjusting further comprises:
retrieving an individual estimation accuracy score pertaining to one or more of the project members from the AI system, wherein the adjusting is based on the project members' individual estimation accuracy scores and their respective estimates.

10. The information handling system of claim 8 wherein the adjusting further comprises:
retrieving an individual expertise score pertaining to one or more of the project members from the AI system, wherein the adjusting is based on the project members' individual expertise scores and their respective estimates.

11. The information handling system of claim 8 wherein the actions further comprise:
retrieving an individual estimation accuracy score pertaining to one or more of the project members from the AI system;
retrieving an individual expertise score pertaining to one or more of the project members from the AI system, wherein the adjusting is based on the project members' individual estimation accuracy scores, their individual expertise scores, and their respective estimates.

12. The information handling system of claim 11 wherein the actions further comprise:
receiving a project novelty score pertaining to a novelty of the project, wherein the adjusting is further based on the project novelty score.

13. The information handling system of claim 8 wherein the training further comprises:
calculating a difference between one or more project members' estimates and an actual completion value included in the respective project members' completion data sets, wherein the training of the AI model is based on the calculated difference.

14. The information handling system of claim 8 wherein the actions further comprise:
communicating the risk level of the project to each of the project members prior to receiving the completion data sets from the project members.

15. A computer program product stored in a computer readable storage medium, comprising computer program code that, when executed by an information handling system, performs actions comprising:
receiving a plurality of estimates pertaining to tasks in a project, wherein each of the estimates is received from one of a plurality of project members working on an agile project;
adjusting one or more of the plurality of estimates with one or more corrections received from an artificial intelligence (AI) system using a previously trained model, wherein each of the corrections pertain to one of the plurality of estimates, and wherein the adjusted estimates are combined with any unadjusted estimates to form a plurality of corrected estimates;
determining a risk level of the project based on the plurality of corrected estimates;
receiving a plurality of completion data sets from the project members upon completion of the project members' respective tasks; and
further training the AI system's model using the received completion data sets.

16. The information handling system of claim 15 wherein the adjusting further comprises:
retrieving an individual estimation accuracy score pertaining to one or more of the project members from the AI system, wherein the adjusting is based on the project members' individual estimation accuracy scores and their respective estimates.

17. The information handling system of claim 15 wherein the adjusting further comprises:
retrieving an individual expertise score pertaining to one or more of the project members from the AI system, wherein the adjusting is based on the project members' individual expertise scores and their respective estimates.

18. The information handling system of claim 15 wherein the actions further comprise:
retrieving an individual estimation accuracy score pertaining to one or more of the project members from the AI system;
retrieving an individual expertise score pertaining to one or more of the project members from the AI system, wherein the adjusting is based on the project members' individual estimation accuracy scores, their individual expertise scores, and their respective estimates.

19. The information handling system of claim 18 wherein the actions further comprise:
receiving a project novelty score pertaining to a novelty of the project, wherein the adjusting is further based on the project novelty score.

20. The information handling system of claim 15 wherein the training further comprises:
calculating a difference between one or more project members' estimates and an actual completion value included in the respective project members' completion data sets, wherein the training of the AI model is based on the calculated difference.
